(19) United States
(12) Patent Application Publication
(10) Pub. No.: US 2011/0286211 A1
(43) Pub. Date: Nov. 24, 2011

(54) LUMINAIRE

(75) Inventor: Hidenao KUBOTA, Yokohama (JP)

(73) Assignee: HITACHI CONSUMER ELECTRONICS CO., LTD.

(21) Appl. No.: 13/090,243

(22) Filed: Apr. 19, 2011

(30) Foreign Application Priority Data
May 18, 2010 (JP) 2010-114391

(51) Int. Cl. F21S 10/02; F21V 7/04; F21V 8/00

(52) U.S. Cl. 362/231; 362/236; 362/247

(57) ABSTRACT

A luminaire using LEDs emits illumination light with improved uniformity and allows selection of color temperature and a region from which light is emitted. The illumination light from the LED travels in a light guide plate and is reflected off the inner surface to output to the outside through a diffuser plate. A plurality of LEDs differing in hue is provided. An LED driver unit controls a color temperature of light to be emitted, and generates, for example, illumination light of moderate color such as an orange color. The LED driver unit switches between regions from which light is emitted, thus offering unique illumination effects and using the luminaire as an all-night lamp. The light guide plate is secured to the side opposite to the reflector sheet in order to prevent the fixing member from impairing the light uniformity.

### INCORPORATION BY REFERENCE

This application relates to and claims priority from Japanese Patent Application No. 2010-114391 filed on May 18, 2010, the entire disclosure of which is incorporated herein by reference.

### BACKGROUND OF THE INVENTION

(1) Field of the Invention

This invention relates to a luminaire, more particularly, to a luminaire capable of controlling color temperature of illumination light, and a position and the area from which light is emitted.

(2) Description of the Related Art

An LED (Light Emitting Diode) requires lower power consumption than that required by incandescent bulbs, fluorescent tubes and the like in the related art, and therefore is becoming widespread as a light-emitting device for illumination.

Japanese Patent Application Laid-Open No. 2010-49865 discloses a technique for facilitating control luminous intensity distribution curves in a luminaire having a surface light source module with a plurality of LED devices. Japanese Patent Application Laid-Open No. 2009-231028 discloses a technique for inhibiting the reduction in luminous efficiency in an LED module lighting downward and upward.

### SUMMARY OF THE INVENTION

LEDs have been used as a backlight of a liquid crystal display for some time. At present, a flat-type luminaire to which the structure of a backlight of a liquid crystal display is adapted is under development. However, additional improvements required for use as a luminaire have been pointed out. For example, the backlight of the liquid is required to emit white light with a high color temperature, but white light is not always appropriate in the use as light of the luminaire. Since light with a somewhat low color temperature, for example, orange light, makes a relaxed atmosphere, this is desired by numerous users.

For the purpose of achieving a new type of luminaire instead of a related-art luminaire, it is desirable to develop a new luminaire effectively using a structure peculiar to the backlight of the liquid crystal display.

The present invention has been made in view of the above circumstances and provides a luminaire capable of controlling the color temperature of illumination light and the position and/or the area from which light is emitted.

To address the above, the present invention provides a luminaire with LEDs as light-emitting devices. The luminaire comprises a base chassis holding the luminaire, an LED board mounted on the base chassis, a plurality of LEDs mounted on the LED board, a plurality of light guide plates each of which emits light from a predetermined number of LEDs of the plurality of LEDs to the outside of the luminaire as illumination light; and a controller that controls the plurality of LEDs for lighting. In the luminaire, the controller selects the LEDs assigned to a light guide plate of the plurality of light guide plates from which the illumination light is to be emitted, and controls the selected LEDs to cause the selected LEDs to light.

The present invention also provides a luminaire with LEDs as light-emitting devices which comprises a base chassis holding the luminaire, an LED board mounted on the base chassis, a plurality of LED sets mounted on the LED board, each LED set including LEDs emitting lights of different hues from each other, a plurality of light guide plates emitting lights from the plurality of LED sets to the outside of the luminaire as illumination light, and a controller that controls the plurality of LED sets for lighting. The controller controls lighting of the LEDs included in the LED set and emitting lights of different hues from each other to cause the LEDs to light at different intensities according to a hue of predetermined illumination light.

According to the present invention, it is possible to provide a luminaire capable of controlling a color temperature of illumination light and a site and/or the area from which light is emitted. There is an advantageous effect of providing a new type of luminaire responding to a trend of energy savings of users.

### BRIEF DESCRIPTION OF THE DRAWINGS

These and other features, objects and advantages of the present invention will become more apparent from the following description when taken in conjunction with the accompanying drawings wherein:

FIG. 1 is an exploded view of a luminaire according to an embodiment of the present invention;

FIG. 2A is an exterior view of a light guide plate according to an embodiment of the present invention;

FIG. 2B is a sectional view of a light guide plate according to an embodiment of the present invention;

FIG. 2C is a sectional view of a light guide plate according to an embodiment of the present invention;

FIG. 3 is an exploded view of a luminaire according to an embodiment of the present invention;

FIG. 4A is a sectional view partially showing the interior of a luminaire according to an embodiment of the present invention;

FIG. 4B is a sectional view partially showing the interior of a luminaire according to an embodiment of the present invention;

FIG. 4C is a sectional view partially showing the interior of a luminaire according to an embodiment of the present invention;

FIG. 5 is a sectional view of a luminaire according to an embodiment of the present invention;

FIG. 6 is a circuit block diagram of a luminaire according to an embodiment of the present invention;

FIG. 7 is a circuit diagram illustrating LEDs and their surroundings according to an embodiment of the present invention;

FIG. 8 is a front view illustrating a lighting sate of the luminaire according to an embodiment of the present invention;

FIG. 9 is a front view illustrating another lighting sate of the luminaire according to an embodiment of the present invention.

### DETAILED DESCRIPTION OF THE EMBODIMENT

An embodiment according to the present invention will be described below in detail with reference to the drawings.

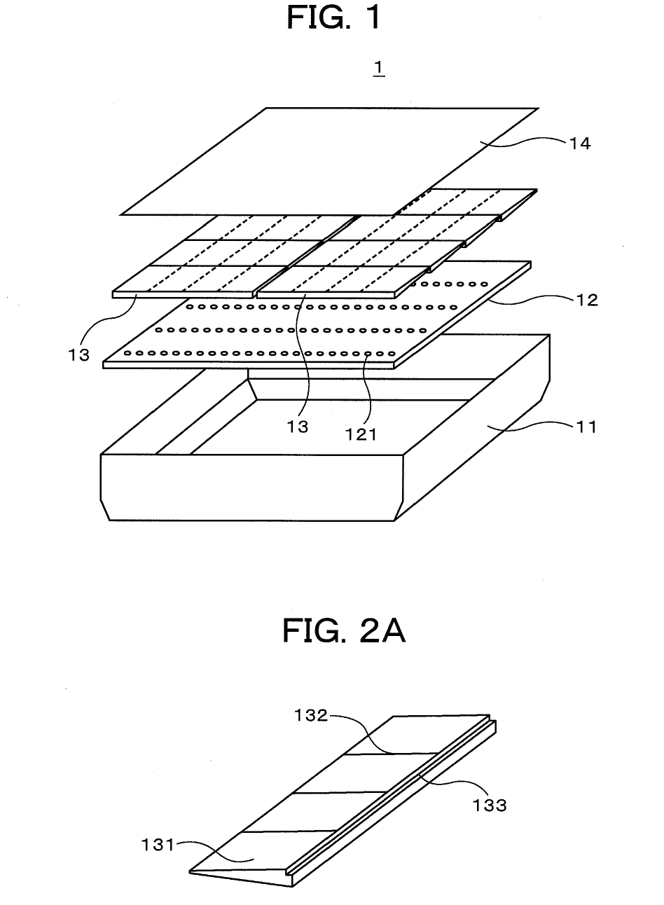

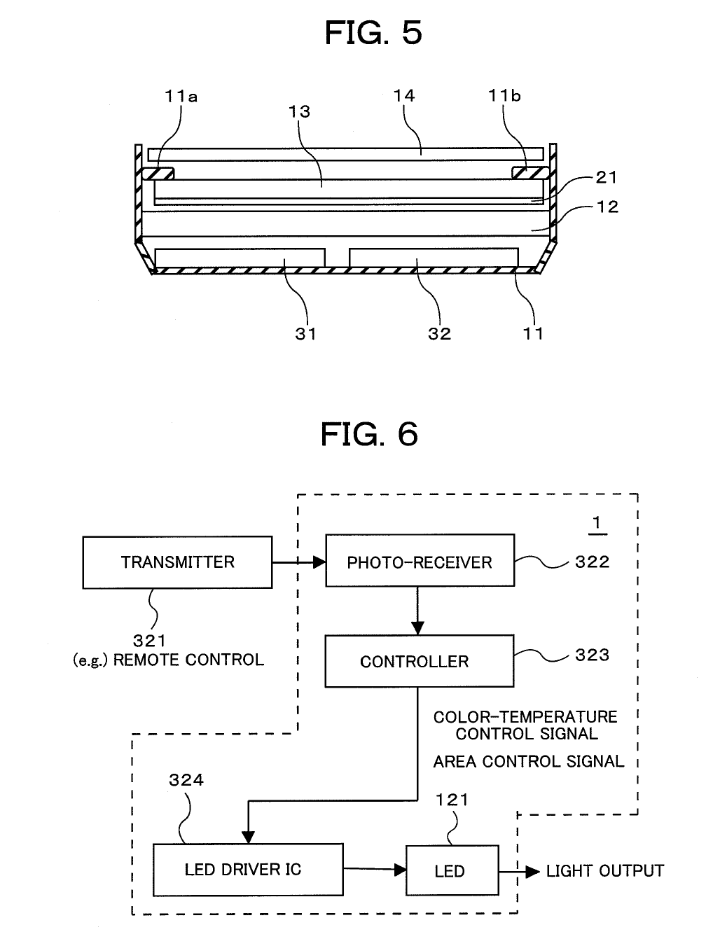

FIG. 1 is an exploded view of a luminaire 1 according to an embodiment of the present invention. FIG. 1 mainly shows the light emission unit and its surroundings, in which, for example, an electric circuit and the like are omitted. FIG. 1 shows some structural elements separated at distance from each other in the height direction but, for actual operation as a luminaire, the many structural elements including them are assembled in close to or in contact with each other as shown in FIG. 5.

A base chassis 11 holds the entire luminaire 1, which may also serve as the exterior. An LED board 12 is secured to the base chassis 11 by, for example, screws. The LED board 12 has numerous light-emitting diodes (LEDs) 121 mounted thereon for emission of illumination light. Each of the LEDs 121 is mounted in such a manner as to protrude from the LED board 12 in the upper direction in FIG. 1. The mount direction of the LED 121 is defined such that illumination light with high intensity is emitted in the direction parallel to the LED board 121.

Light guide plates 13 are mounted such that the LED 121 is placed in a hole formed in an end of each of the light guide plates 13 as described later. This embodiment employs a combination of the 8 light guide plates 13 in total arranged in 4 rows and 2 columns by way of example. The illumination light emitted from the LED 121 travels mainly in a direction parallel to the LED board 12 within the corresponding light guide plate 13, during which the illumination light is repeatedly reflected off the inner surface of the light guide plate 13. Then, the illumination light enters a diffuser plate 14. The illumination light incident on the diffuser plate 14 is increased in uniformity in the planar direction in the diffuser plate 14, and then output mainly in the upper direction in FIG. 1. In the use of the luminaire 1 as a ceiling lamp, the luminaire 1 is attached to the ceiling with the top side shown in FIG. 1 facing downward.

In FIG. 1, the LED 121 mainly emits light in the direction parallel to the LED board 12 and the emitted light is reflected almost at right angles to the LED board 12 by the light guide plate 13. This is because the thickness of the luminaire 1 can be reduced as compared with the case of emitting light in the vertical direction from the very beginning. In other words, the degree of flexibility in design of the luminaire 1 can be increased. This type of light emission mechanism is called tandem light emission mechanism.

The tandem light emission mechanism is also used for a backlight of a liquid crystal display. Since the illumination light output from the diffuser plate 14 has a high uniformity because of the action of the light guide plate 13 and the diffuser plate 14, the tandem light emission mechanism is suitable for use in a backlight of a large-screen display unit. However, the uniformity of output light is also a very important factor for a luminaire. For example, an incandescent bulb or a fluorescent lamp does not easily produce uniform illumination even if the bulb or lamp is shaded. Therefore, when a person looks the light straight in the eye, he may possibly recognize a bright point, causing eye fatigue. The embodiment addresses this disadvantage. Also, since the diffuser plate 14 is uniformly light, the effect of creating a high quality appearance is produced.

In this manner, the luminaire according to the embodiment includes a plurality of sets of the LEDs and light guide plate that are arranged two-dimensionally (in a matrix form) on the base chassis 11.

In a liquid crystal display, as is known, a liquid crystal panel with a liquid crystal shutter is mounted on the upper side of the diffuser plate 14 in FIG. 1, and therefore by use of the aforementioned illumination light as backlight, an image of, for example, TV broadcasting or the like can be displayed. In the embodiment, if a liquid crystal panel, a broadcasting receiver circuit, a driver of a liquid crystal shutter and the like are provided, the function as a liquid crystal display can be provided, and also the luminaire can also serve as a display unit. An embodiment as a luminaire is here disclosed.

Next, the light guide plate 13 will be described.

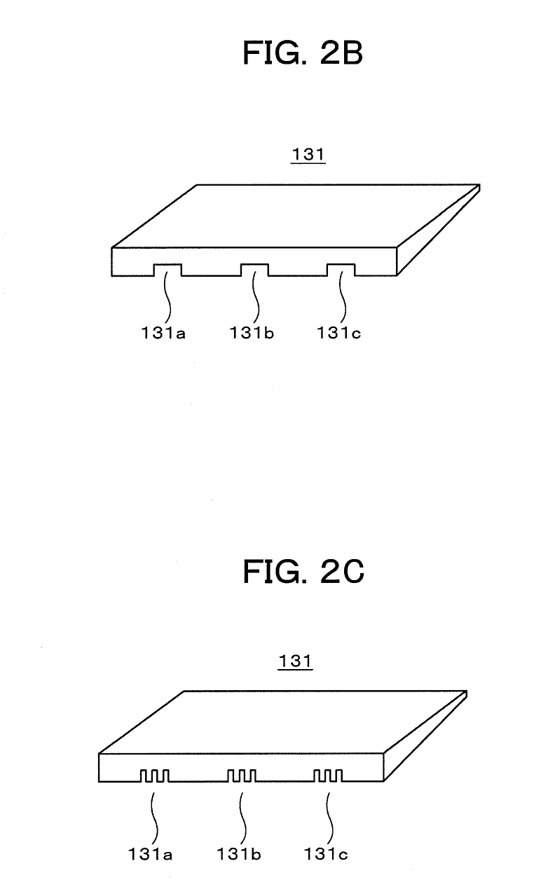

FIG. 2A is an exterior view of the light guide plate 13 according to an embodiment of the present invention, in which the light guide plate 13 shown in FIG. 1 is turned upside down. The light guide plate 13 is made up of, for example, a combination of four light guide sub-blocks 131 which are joined with a groove 132 formed between the two adjacent sub-blocks 131. It should be understood that the light guide plate 13 may be originally formed as one piece without being divided into sub-blocks. The light guide plate 13 has a wedge-shaped cross section such that the illumination light traveling approximately parallel to the surface of the light guide plate 13 is reflected off the inner face to travel toward the diffuser plate 14. Accordingly, when seen as a luminaire, the surface in the back (the upper side in FIG. 2A) is curved. A nick 133 is provided at an end of the surface in the back for overlapping an end of the adjacent light guide plate.

Each of FIGS. 2B and 2C is a sectional view of a light guide plate according to an embodiment of the present invention. Each of FIGS. 2B and 2C shows a section of a light guide sub-block 131 when a portion of the light guide plate 13 around the nick 133 in FIG. 2A is cut in the vertical direction in FIG. 2A. The up and down direction in each FIG. 2B, 2C is opposite to that in FIG. 2A and is the same as that in FIG. 1. The holes 131a to 131c are formed at an end of each light guide sub-block 131 for receiving the LEDs 121.

In the liquid crystal display, the LEDs emitting white light (W) are placed in the holes 131a to 131c in FIG. 2B. However, a feature of the luminaire according to the embodiment is that, for example, three types of LEDs are placed in the holes 131a to 131c in FIG. 2B. The three types are, for example, a set of while light (W), red light (R) and blue light (B) or a set of red light (R), blue light (B) and green light (G). Alternatively, the LEDs may be of two types, for example, a set of W and R or a set of R and G. In any case, the luminaire is adapted to provide illumination light with a designated color temperature as well as simple white light. For example, a visually soft orange color, warm white color or the like with a relatively low color temperature can be easily realized by appropriately setting the light-emission intensities of a plurality of LEDs.

When the three types of LEDs are used, for example, each of the holes 131a to 131c may have three slots as shown in FIG. 2C and an LED may be placed in each slot. In the following, LEDs of different hues placed in the same hole of the light guide sub-block 131 may be called a set of LEDs in some instances.

In FIGS. 2B and 2C, the LEDs situated in the holes 131a to 131c may emit illumination light mainly toward the light guide sub-block 131 having these holes 131a to 131c or may emit illumination light simultaneously toward the relevant light guide sub-block 131 and the adjacent light guide sub-block (the light guide sub-block located on this side in FIG. 2B or 2C).

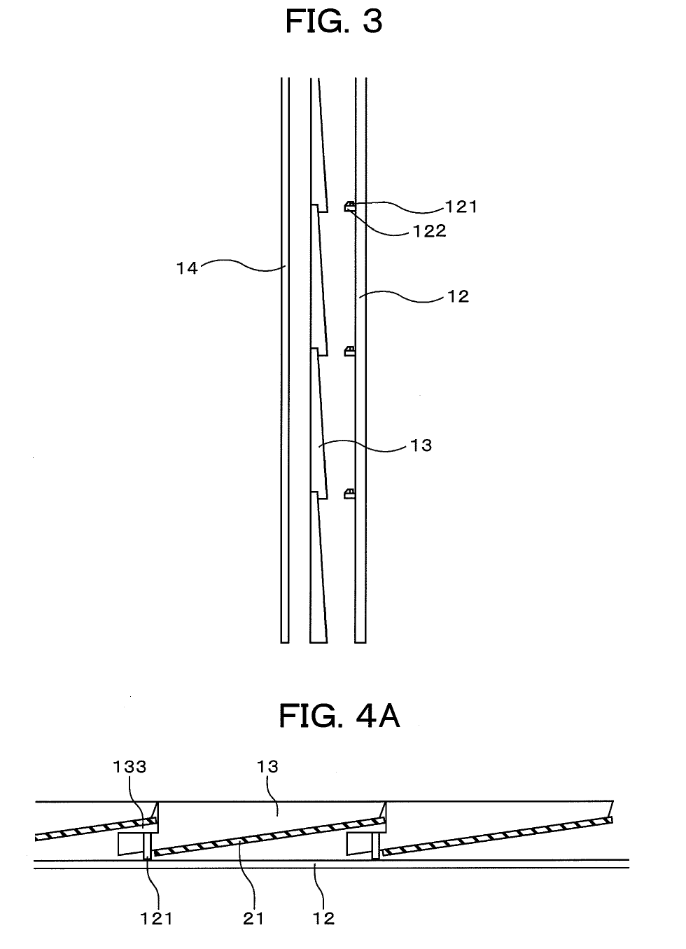

FIG. 3 is an exploded view of a luminaire 1 according to an embodiment of the present invention, which shows the positional relationship of the LED board 12, LEDs 121, the light guide plates 13 and the diffuser plate 14 when viewed from the right hand in FIG. 1. In this embodiment, as the LED 121, a so-called side-view LED emitting light in a direction parallel to the electrode surface may be used or a so-called top-view LED emitting light in a direction at right angles to the electrode surface may be used. In the example in FIG. 3, the top-view LED is used as the LED 121. For this reason, in order to emit light from the top-view LED in a direction parallel to the LED board 12, a sub-board 122 is attached to the LED board 12 to extend in a direction perpendicular to this LED board 12, and the top-view LED 121 is mounted on the sub-board 122. Accordingly, if the top-view LED is used, the light emitted from the LED (light axis) is allowed to travel in the direction parallel to the surface of the LED board 12. In the use of the side-view LED, the LED can be mounted directly on the LED board 12 (without the sub-board 122), leading to a reduction in component count. A combination of the LED 121 and the sub-board 122 will be hereinafter referred to simply as an LED 121.

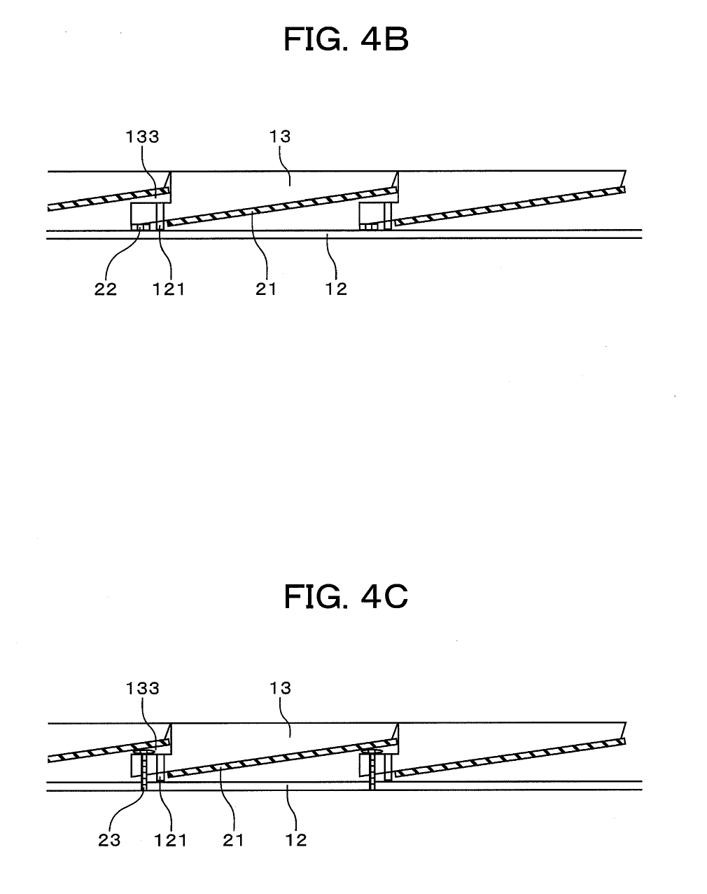

Each of FIGS. 4A to 4C is a sectional view partially showing the interior of a luminaire 1 according to an embodiment of the present invention. Unlike the case of FIG. 1, each of FIGS. 4A to 4C shows a portion of the assembled luminaire around the LED board 12, the LEDs 121 and the light guide plate 13 when it is actually used. In FIG. 4A, an LED 121 is situated in a hole formed in an end of the light guide plate 13. Each light guide plate 13 has a nick 133 formed at its end and overlapping another light guide plate adjacent thereto. A reflector sheet 21 hatched in FIGS. 4A to 4C is provided as a structural component which is not shown in FIG. 1. The reflector sheet 21 is provided on the inner surface on the back side (on the underside in FIGS. 4A to 4C) of the light guide plate 13 for effective reflection of the illumination light.

FIG. 4B shows an example when the light guide plate 13 shown in FIG. 4A is secured to the LED board 12 with an adhesive (or a double-faced adhesive tape) 22. FIG. 4C shows an example when the light guide plate 13 shown in FIG. 4A is secured to the LED board 12 with a mounting screw 23. In any case, the adhesive 22 and the mounting screw 23 are located on the back of the reflector sheet 21 when viewed from the front side of the luminaire, that is, from the upper side in FIGS. 4B, 4C so that the user cannot visually recognize them. For this reason, a structural component for mounting the light guide plate 13 is precluded from causing loss of the uniformity of the illumination light, and also the shape of the structural component is precluded from being unsightly recognized.

FIG. 5 is a sectional view of a luminaire 1 according to an embodiment of the present invention. Unlike the case of FIG. 1, FIG. 5 shows a sectional view of the assembled luminaire 1 for actual use when it is cut in the vertical direction in FIG. 1. Protrusions 11a, 11b may be provided on portions of the hatched base chassis 11 in order to support the light guide plate 13 by a different method from the methods of using the adhesive 22 and the mounting screw 23. FIG. 5 illustrates a circuit board. A power-supply board 31 is mounted with an LED drive circuit for generating a power supplied to the entire luminaire 1 to drive the LEDs 121 for lighting control. A microcomputer control board 32 is mounted with a control circuit for controlling the operation of the luminaire 1 in response to, for example, an instruction received from a remote control. It should be understood that such circuits may be mounted on the same board.

As described earlier, when the luminaire is of the type of being directly attached to the ceiling for use, the luminaire is attached to the ceiling with the top side in FIG. 5 facing downward. Since a flat light emission type luminaire as described in the embodiment is easily designed into a low-profile shape, it can be advantageously designed to facilitate cleaning because of a significantly reduced region in which dust is accumulated.

Next, a method of controlling color temperature of illumination light and a position and/or the area from which light is emitted in the embodiment will be described with reference to the drawings.

FIG. 6 is a circuit block diagram of the luminaire 1 according to the embodiment of the present invention. The user operates, for example, a remoter control associated with the luminaire, so that a transmitter 321 of the remoter control transmits a remote-control signal including an action command to the luminaire 1. A photo-receiver 322 of the luminaire 1 receives, for example, an infrared command signal transmitted from the transmitter 321, and then transmits it to a controller 323 including, for example, a microcomputer. The controller 323 analyzes command contents from the user on the basis of the remote-control signal received by the photo-receiver 322. The infrared ray is not required to use for the action command of the user, and the luminaire 1 may be provided with a mechanical switch to preset action.

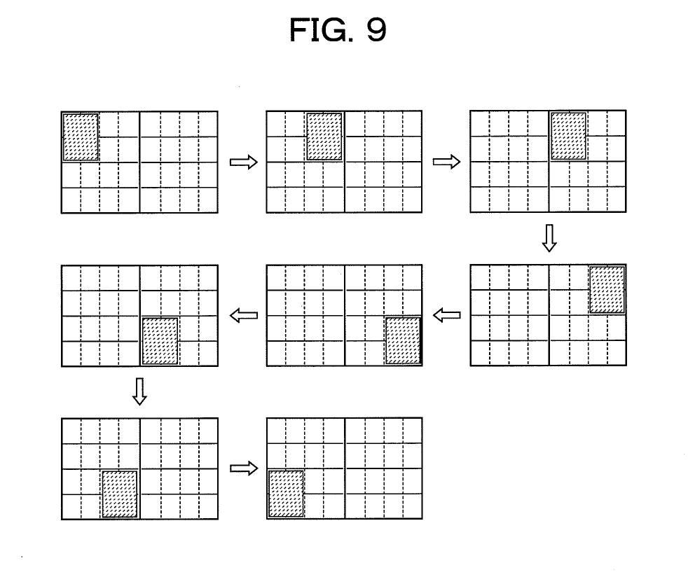

In the embodiment, the action commands from the transmitter 321 include not only a command signal to turns on/off the luminaire 1 but also a signal for controlling the color temperature of illumination light, a signal for controlling the position and/or the area from which light is emitted. Specifically, a feature in the embodiment is to enable the user to select a color temperature of the illumination light and an region of the luminaire for light emission. Accordingly, the user is enabled to select color temperature light suitable for use conditions from various types of color light including a low color temperature light such as of an orange color, primary color light such as of a red color or a blue color and a high color temperature light such as white light. Another feature is to enable the user to select from which region of the luminaire he wants light emission, which will be described later with reference to FIGS. 8 and 9. Note that a region here described is assumed to correspond to each light guide sub-block and the LEDs assigned to this light guide sub-block.

Upon reception of the results of analysis of the command contents in the photo-receiver 322, the LED driver IC 324 selects designated LEDs 121 from the total number of LEDs 121 and control the lighting-up of the selected LEDs 121. The light emitted from the selected LEDs 121 undergoes the above-described process and then is output as illumination light of the luminaire 1.

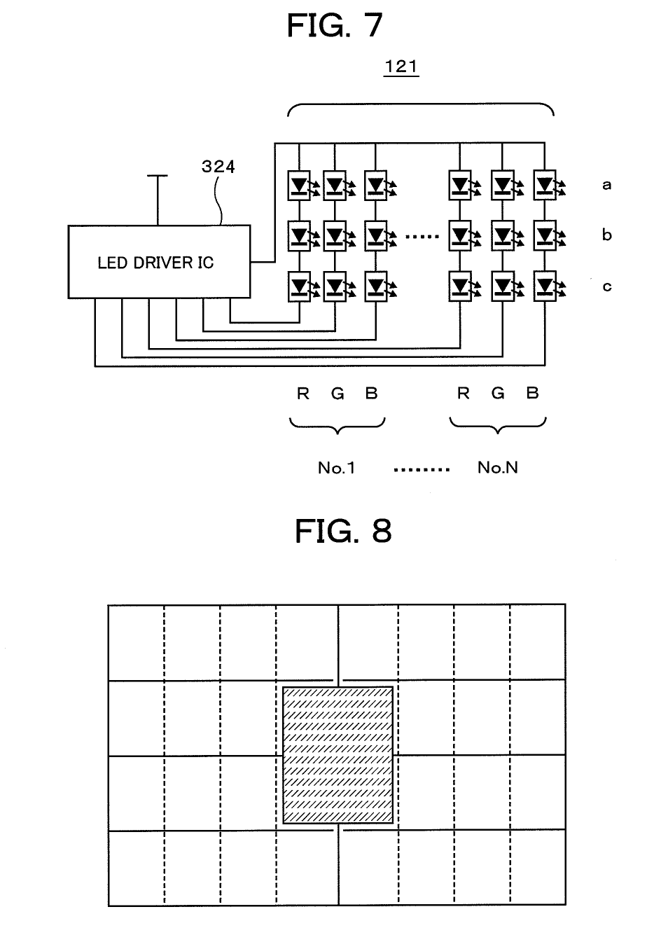

FIG. 7 is a circuit diagram illustrating the LEDs 121 of the luminaire and their surroundings according to an embodiment of the present invention. A plurality of the LEDs 121 is connected to the LED driver IC 324 through circuit connection illustrated in FIG. 7 by way of example. In FIG. 7, each of N LED sets No. 1 to No. N has, for example, 9 LEDs. Each LED set is situated in the holes 131a to 131c of each light guide sub-block 131 as illustrated in FIG. 2B or 2C.

For example, in the LED set No. 1, the three LEDs connected in series in the vertical direction in FIG. 7 are of the same hue, while the three columns of LEDs connected in parallel in the lateral direction are of hues different from each other. In the example illustrated in FIG. 7, the LEDs of the three R, G, B colors are provided so that the luminaire is adapted to emit light at all color temperatures in principle. In the LEDs of each color, the top LED of the three LEDs connected in series in the vertical direction in FIG. 7 is placed in the hole 131a shown in FIG. 2B or 2C, the middle LED in the hole 131b and the bottom LED in the hole 131c. When each hole has the three slots as shown in FIG. 2C, the LEDs of different colors are respectively placed in the slots.

The LED driver IC 324 controls the brightness of each of the three LEDs connected to in series according to a control signal from the photo-receiver 322 for lighting-up, thus making it possible to select not only a color temperature of illumination light but also only a designated region of the luminaire 1 in order for the luminaire 1 to light up.

For example, if the aforementioned orange light is desired, the R LED and the G LED are operated to light up and also the G LED is operated light up at a lower intensity than that of the R LED.

In some cases, the luminaire 1 is not required to fully light up. For example, a small-ball bulb (or jujube ball) is known and often used for an all-night light. The embodiment can provide a luminaire instead of the small-ball bulb by means of control of the area from which light is to be output as described later, resulting in further reduction in power consumption.

FIG. 8 is a front view illustrating a lighting sate of the luminaire 1 according to an embodiment of the present invention. Specifically, the LED driver IC 324 selects, for example, the LEDs located in a region around the center of the luminaire 1 which are hatched in FIG. 8 and operates them to light up, thus providing an all-night light with sufficient light uniformity. Such a selected region is not limited to the region around the center of the luminaire 1, and another region can be lighted as an all-night light.

FIG. 9 is a front view illustrating another lighting sate of the luminaire 1 according to an embodiment of the present invention. Specifically, for example, a lighting method can be implemented, in which, with the passage of time shown by the arrows in FIG. 9, a region to be lit is sequentially moved rightward from the upper left region eventually to the lower left region. It should be understood that the user may operate the transmitter 321 to move the region to be lit or the LED driver IC 324 may move the region to be lit at predetermined time intervals. This produces advantageous effects of providing new lighting effects as well as of eliminating the disadvantage that the LEDs in a specific region deteriorate earlier than other LEDs. In FIG. 9, the area of the region to be lit may be varied while a region to be lit is being moved.

If white light is required to be lit in the total area of the luminaire 1, the light intensity may be controlled by adjusting the light emission intensity of the LEDs in the entire region. In place of this, the region in which white light to be lit may be changed. For example, if the brightness of the luminaire 1 is required to be reduced, the LEDs assigned to the 20 regions on the periphery in FIG. 8 may be turned off, while only the LEDs assigned to the central 12 regions may be turned on to emit white light. In an opposite manner, the LEDs assigned to the central 12 regions are turned off, while the LEDs assigned to the 20 regions on the periphery may be lit to emit white light. Further, in regular lighting of the luminaire 1, for example, a daylight color with a low color temperature (of about 6000 K to about 6500 k) with which yellow is slightly mixed is often preferred to white light with a color temperature in a range from 9000 K to 10000 K. If the user wants to change the illumination light color to the daylight color, the user operates the remote control to reduce the color temperature, whereupon the controller 323 controls the LEDs such that a white color and the green and red LEDs are lit in the entire region according to the remote control signal. In this case, the light emission intensity of the green and red LEDs is controlled to a range from about some percent to about 10 percent as compared with a white color. It should be understood that only a part of the region, not the entire region, may emit daylight color light.

The aforementioned description has given of the example that the light guide plate includes 8 light guide plates, each of the light guide plates includes 4 light guide sub-blocks, and three systems of LEDs are managed on each of the light guide sub-blocks, but which is illustrative only and is not a defined condition of the embodiments. Much more modifications, including embodiments of changing the number of light guide plates or light guide sub-blocks or the number of systems of LEDs, can be considered, all of which are included in the scope of the present invention.

While we have shown and described several embodiments in accordance with our invention, it should be understood that disclosed embodiments are susceptible of changes and modifications without departing from the scope of the invention. Therefore, we do not intend to be bound by the details shown and described herein but intend to cover all such changes and modifications that fail within the ambit of the appended claims.

What is claimed is:

1. A luminaire with LEDs as light-emitting devices, comprising:
a base chassis holding the luminaire;
an LED board mounted on the base chassis;
a plurality of LEDs mounted on the LED board;
a plurality of light guide plates, each light guide plate emitting light from a predetermined number of LEDs of the plurality of LEDs to the outside of the luminaire as illumination light; and
a controller that controls the plurality of LEDs for lighting,
wherein the controller selects the LEDs assigned to a light guide plate of the plurality of light guide plates from which the illumination light is to be emitted, and controls the selected LEDs to cause the selected LEDs to light.

2. The luminaire according to claim 1, wherein the controller has a lighting control mode of lighting all the LEDs.

3. The luminaire according to claim 1, wherein the controller changes the LEDs to emit light in accordance with a command of a user or a lapse of time for lighting control.

4. A luminaire with LEDs as light-emitting devices, comprising:
a base chassis holding the luminaire;
an LED board mounted on the base chassis;
a plurality of LED sets mounted on the LED board, each LED set including LEDs emitting lights of different hues from each other;
a plurality of light guide plates emitting lights from the plurality of LED sets to the outside of the luminaire as illumination light; and
a controller that controls the plurality of LED sets for lighting,
wherein the controller controls lighting of the LEDs included in the LED set and emitting lights of different hues from each other to cause the LEDs to light at different intensities according to a hue of predetermined illumination light.

5. The luminaire according to claim 4, wherein the controller selects LED sets emitting the illumination light guided by a predetermined number of light guide plates included in the plurality of light guide plates, and controls the selected LED sets to cause them to light.

6. The luminaire according to claim 5, wherein the controller unit changes the LED sets to emit light in accordance with a command of a user or a lapse of time for lighting control.

7. The luminaire according to claim 1, wherein
the light guide plates have reflector members for reflecting the illumination light onto surfaces facing the LED board, a part of each of the light guide plates being disposed to be superimposed on a part of the adjacent light guide plate on opposite sides of a corresponding one of the reflector members, and
the adjacent light guide plate is attached to the LED board on a portion superimposed on the light guide plate by a fixing member provided between the LED board and the reflector member provided on the light guide plate.

8. The luminaire according to claim 4, wherein
the light guide plates have reflector members for reflecting the illumination light onto surfaces facing the LED board, a part of each of the light guide plates being disposed to be superimposed on a part of the adjacent light guide plate on opposite sides of a corresponding one of the reflector members, and
the adjacent light guide plate is attached to the LED board on a portion superimposed on the light guide plate by a fixing member provided between the LED board and the reflector member provided on the light guide plate.
